(19) United States
(12) Patent Application Publication
(10) Pub. No.: US 2010/0296278 A1
(43) Pub. Date: Nov. 25, 2010

(54) Plant Illumination Device And Greenhouse Provided With A Plant Illuminating Device

(75) Inventor: Teunis Cornelis van den Dool, Monster (NL)

Correspondence Address: TROUTMAN SANDERS LLP;5200 BANK OF AMERICA PLAZA, 600 PEACHTREE STREET, N.E., SUITE 5200, ATLANTA, GA, 30308-2216, US

(73) Assignee: Hortilux Schreder B.V., Monster (NL)

(21) Appl. No.: 12/445,620

(22) PCT Filed: Oct. 24, 2007
(86) PCT No.: PCT/NL07/00272

§ 371 Date: Apr. 15, 2009

(30) Foreign Application Priority Data
Oct. 30, 2006 (NL) 1032775

(51) Int. Cl. F21V 9/00

(52) U.S. Cl. 362/231

(57) ABSTRACT

The invention relates to a plant illumination device for exposing to light plants that are to be grown in a greenhouse, which plant illumination device comprises: at least one lighting fitting with a first light source, which first light source is an assimilation lamp in the form of an incandescent lamp or a gas discharge lamp, the first light source having a first spectrum, and said first light source having a power of at least 250 W; —at least one additional lighting unit (5) with an additional light source, which additional light source has an additional spectrum which differs significantly from the first spectrum, and in which the additional spectrum complements the first spectrum in at least a wavelength range which plays a role in a biological process in the plants to be exposed to light.

The invention relates to a plant illumination device for exposing to light plants to be grown in a greenhouse.

US 2001/0047618 discloses a device for growing plants. This known device comprises an enclosed space with a number of tiers in which plants are artificially exposed to light. The lighting is achieved by means of light-emitting diodes (LEDs). For each growing tier, LEDs emitting red light and LEDs emitting blue light are both present.

The known device is unsuitable for use in greenhouses because the ratio between the intensity of the emitted light and the energy consumption is too unfavourable. The LEDs produce more heat than is desirable during use, with the result that additional measures have to be taken to cool the greenhouse, because otherwise the temperature in the greenhouse becomes too high.

It is known to use artificial lighting in greenhouses. For this artificial lighting, assimilation lamps in the form of incandescent lamps or gas discharge lamps are used. Such assimilation lamps can generate growing light with sufficient intensity at an acceptable energy consumption level and with an acceptable heat production. A disadvantage of such assimilation lamps is, however, that the spectrum of such lamps is not of the optimum type for supporting the photosynthesis and (photo)morphogenesis of the plants to be exposed to light.

The object of the invention is to provide an improved plant illumination device.

The invention achieves this object with the plant illumination device according to claim 1.

Artificial lighting is used in greenhouse horticulture to support one or more biological processes in the plants present in the greenhouse. The main biological processes to be supported are photosynthesis and (photo)morphogenesis.

In the plant illumination device according to the invention an assimilation lamp in the form of an incandescent lamp or a gas discharge lamp with a capacity of at least 250 W is used. A gas discharge lamp is preferred here. Such a lamp has acceptable efficiency (i.e. the ratio between light output and consumption of electrical energy).

The spectrum of an assimilation lamp in the form of an incandescent lamp or a gas discharge lamp does not correspond entirely to the optimum spectrum for supporting photosynthesis and morphogenesis. The spectrum of such an assimilation lamp lacks the necessary intensity in certain wavelength ranges, in particular in the blue range (with wavelengths of approximately 350-500 nm) and in the red and far-red range (with wavelengths of approximately 600-800 nm).

The plant illumination device according to the invention comprises, in addition to the first light source in the form of an incandescent lamp or gas discharge lamp, a further one or more additional light sources. The spectrum of these additional light sources differs significantly from the spectrum of the first light source. The spectrum of the additional light source or light sources contains a wavelength range which complements the spectrum of the first light source just in those ranges in which the spectrum of the first light source lacks the intensity required for the optimum spectrum for the biological process to be supported, such as photosynthesis and (photo)morphogenesis.

The combination of the spectrum of the first light source with the spectrum of the one or more additional light sources produces a combined spectrum which is closer than the spectrum of the first light source alone to the spectrum desired for supporting the biological process concerned in the plants to be exposed to the light.

The spectrum of natural sunlight varies during the day and during the season. In addition, the spectrum of natural sunlight depends on the region on earth. Research has shown that plants are sensitive to these variations. The spectrum of the light partly determines what effect the light has on the plant. For instance, evening light, a darker period, and then morning light prepare the plant, as it were, for optimum photosynthesis during the middle of the day.

Various photomorphogenetic processes can also be influenced by selecting the spectrum of the growing light in a certain way. If, for example, in nature the fruit set or flowering of a certain plant occurs particularly in a certain season, then the plant can be exposed to light with a spectrum corresponding to the fruit set or flowering season in other seasons as well, so as to promote fruit set or flowering. It is also possible in this way to expose the plants to light with a spectrum such as that occurring in the region of origin of the plants concerned, thus promoting optimum development of the plants.

The additional light sources in the plant illumination device according to the invention can also be used for simulation of this variation in spectrum during the day. For instance, a number of additional light sources can be used in combination with the first light source, which additional light sources have wavelength spectra which differ from each other. It is thus possible in the morning hours to use an additional light source which in particular adds blue light to the spectrum of the first light source, and in the evening hours to use another additional light source which in particular adds red and/or far-red light to the spectrum of the first light source.

A combination of a number of LEDs is suitable as an additional light source. The spectrum of the LED can be defined accurately, so that good complementing of the spectrum of the first light source is achieved.

The one or more additional light sources are accommodated in an additional lighting unit. Said additional lighting unit can be designed separately from the lighting fitting of the first light source. As an alternative, one or more additional lighting units can be connectable to a lighting fitting for a first light source, or one or more additional lighting units can be integral with a lighting fitting for a first light source.

The invention also relates to a greenhouse illumination system comprising a plurality of lighting fittings, each comprising a first light source, and a plurality of additional light units, each comprising one or more additional light sources. The number of lighting fittings in the system does not have to be the same here as the number of additional lighting units in the system.

The invention will be explained below with reference to a drawing, in which an exemplary embodiment is shown in a non-limiting way.

The drawing shows in:

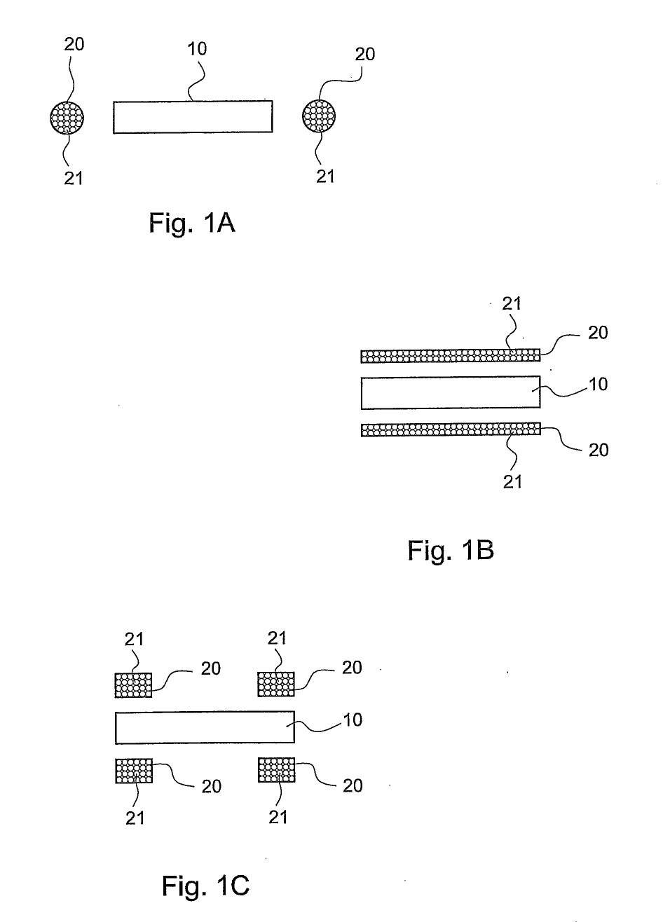

FIGS. 1A-C—examples of relative positioning options for first and additional light sources;

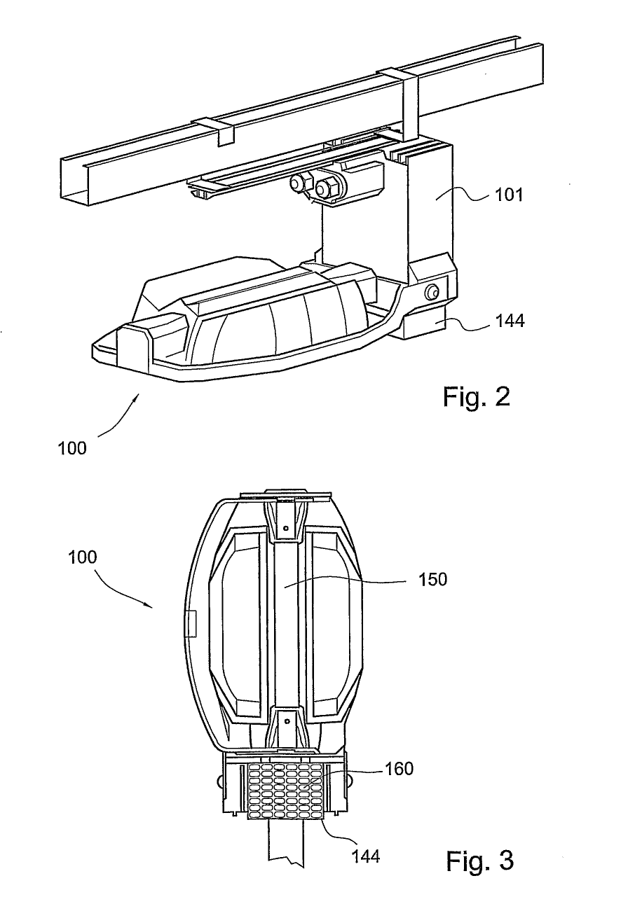

FIG. 2—a first embodiment of a plant illumination device according to the invention;

FIG. 3—a bottom view of the plant illumination device according to FIG. 2;

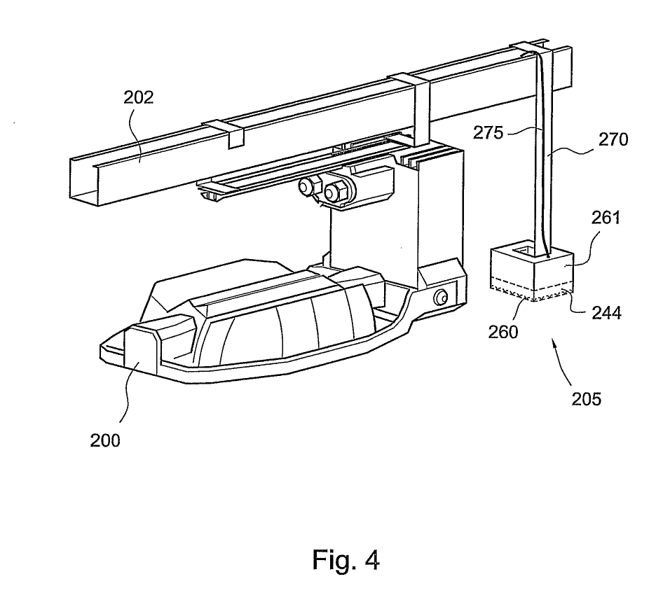

FIG. 4—a second embodiment of a plant illumination device according to the invention;

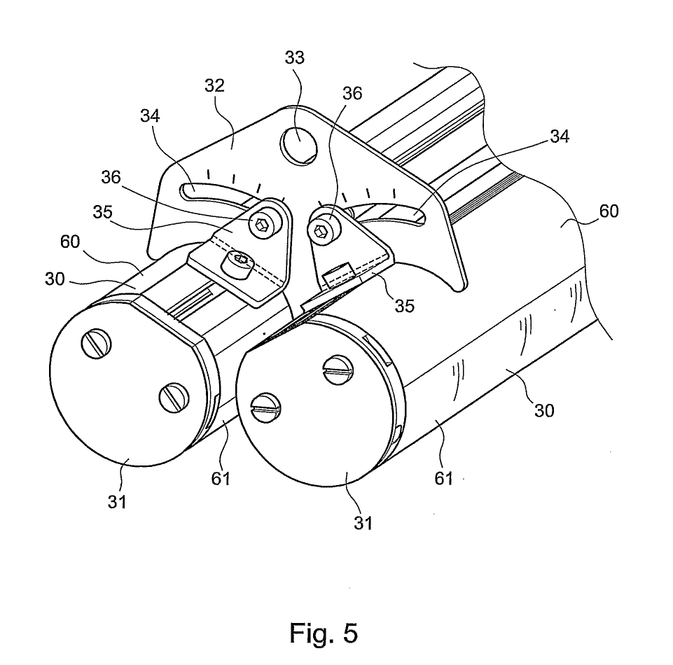

FIG. 5—a part of a third embodiment of a plant illumination device according to the invention;

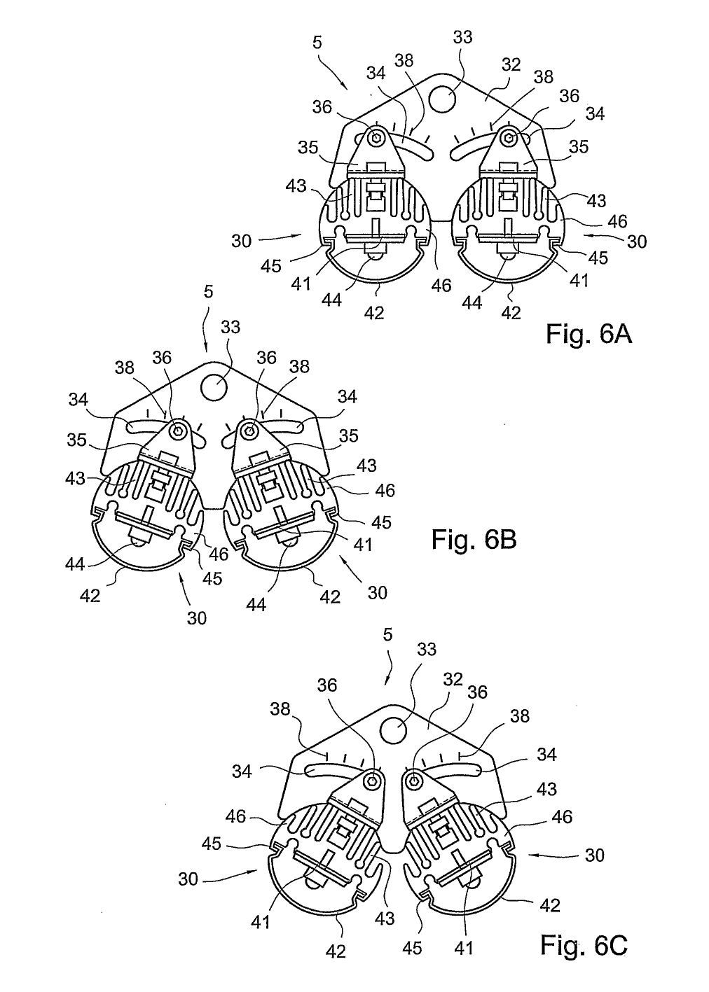

FIGS. 6A-C—three possible positions of the embodiment according to FIG. 5;

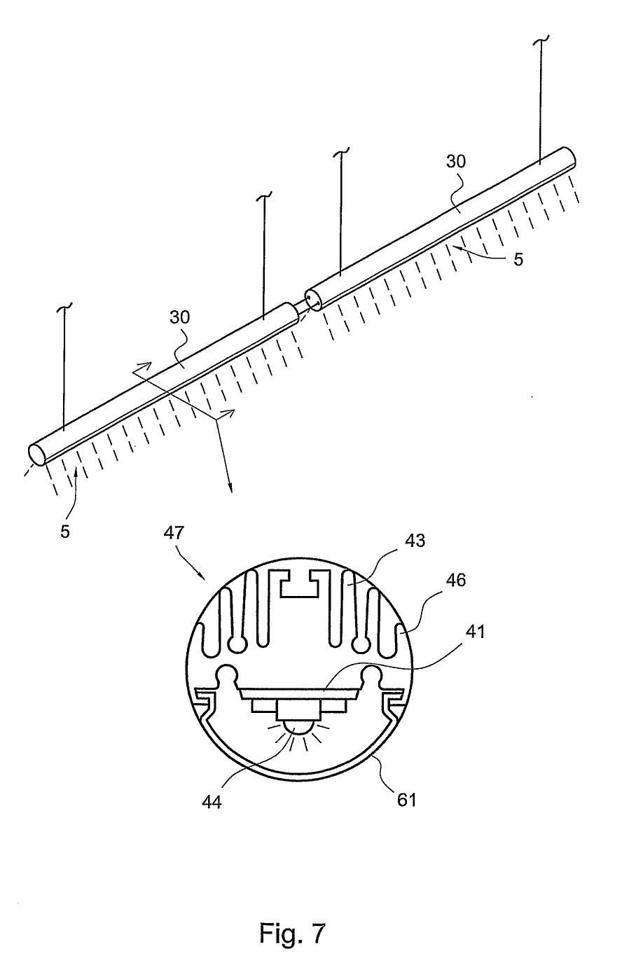

FIG. 7—a further embodiment of a plant illumination device according to the invention;

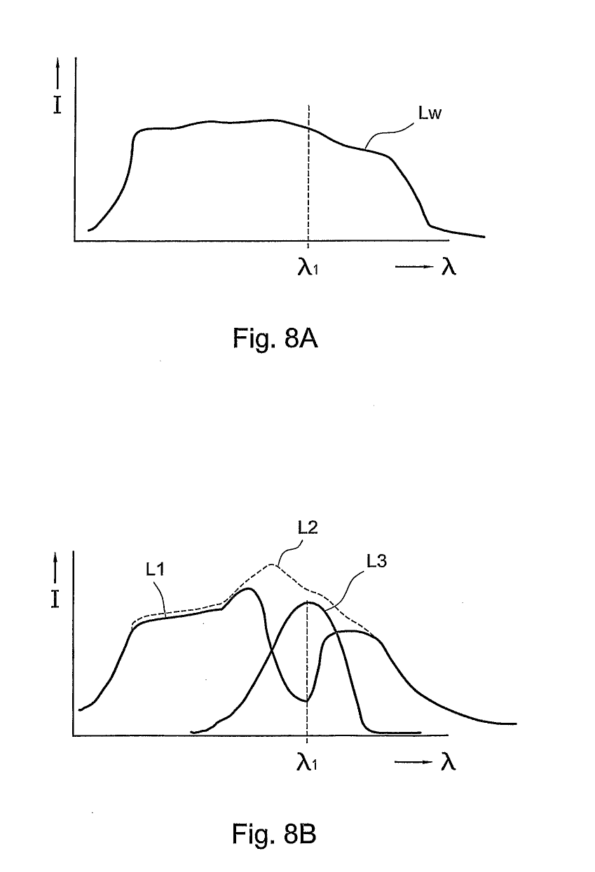

FIG. 8—an example of the method according to the invention.

FIGS. 1A-C show examples of relative positioning options for first and additional light sources in a plant illumination device according to the invention. In FIG. 1 the first light source is indicated by 10, and the additional light sources are indicated by 20.

FIGS. 1A-C give the relative positions of the light sources 10, 20 in a bottom view, such as viewed from the floor of a greenhouse while the crop lighting devices are hanging from the roof structure of the greenhouse.

In the examples of FIGS. 1A-C the first light source 10 is a gas discharge lamp, preferably with a power of 400 W or more.

In FIG. 1A an additional light source 20 is provided at both end sides of the first light source 10, each of which additional light sources comprises a set of LEDs (light-emitting diodes) 21. Both additional light sources can emit light with the same spectrum, but it is also possible to opt for each additional light source 20 to have its own spectrum which differs from that of the other additional light source. The two additional light sources 20 can be on simultaneously, but can also be on separately. Instead of the two additional light sources 20 shown in FIG. 1A, there can also be a single additional light source 20, in combination, of course, with a first light source 10.

In FIG. 1B an additional light source 20 is provided on either side of the long side of the first light source 10, each of which additional light sources again comprises a set of LEDs 21. Additional light sources can emit light with the same spectrum, but it is also possible to opt for each additional light source 20 to have its own spectrum which differs from that of the other additional light source. The two additional light sources 20 can be on simultaneously, but can also be on separately. Instead of the two additional light sources 20 shown in FIG. 1B, there can also be a single additional light source 20, in combination, of course, with a first light source 10.

In FIG. 1C two additional light sources 20 are provided on either side of the long side of the first light source 10, each of which additional light sources again comprises a set of LEDs 21. All additional light sources can emit light with the same spectrum, but it is also possible to opt for each additional light source 20 to have its own spectrum which differs from that of the other additional light source. Pairs of two sources with the same spectrum within a pair and different spectra between the pairs can also be present. All additional light sources 20 can be on at the same time, but they can also be on individually or in groups of two or three. Instead of the four additional light sources 20 shown in FIG. 1C, there can also be a single additional light source 20, or two or three additional light sources, in each case, of course, in combination with a first light source 10.

FIG. 2 and FIG. 3 show a first embodiment of a plant illumination device according to the invention. This embodiment is based on a known lighting fitting 100. The lighting fitting shown in FIGS. 2 and 3 is disclosed in NL1029324, but other known types of lighting fittings can also be used as a basis.

In this exemplary embodiment the first light source 150 is placed in the known lighting fitting 100.

In the embodiment of FIGS. 2 and 3 an additional light source 144 is added to the known lighting fitting 100. The additional light source 144 comprises a set of LEDs 160. In this example also, all LEDs in the set of LEDs can have the same spectrum. As an alternative, LEDs with different spectra can be combined in a single set.

An electronics housing 101 is provided in the known lighting fitting 100. The electronics for controlling the additional light source 144 are also accommodated in this electronics housing 101.

FIG. 4 shows a second embodiment of a plant illumination device according to the invention. In this embodiment the first light source and the additional light source or additional light sources is/are no longer accommodated in the same lighting fitting.

The first light source is present in the known lighting fitting 200. This lighting fitting hangs from a rail 202 of a bearing structure which is known per se. In the example of FIG. 4 the known lighting fitting 200 is again the lighting fitting from NL1029324, but it can, of course, also be a different known lighting fitting. Many of such lighting fittings are generally fitted in a greenhouse.

In the embodiment of FIG. 4, apart from the known lighting fittings 200, separate additional lighting units 205 are also fitted. The greenhouse can have as many lighting fittings 200 as additional lighting units 205, but this is not essential. There can be more additional lighting units 205 than lighting fittings 200, or vice versa.

An additional light source 244 is accommodated in an additional lighting unit 205. The additional light source 244 again comprises a set of LEDs. The additional lighting unit 205 also has a space 261 in which the electronics needed for operating the additional light source are accommodated.

The additional lighting units 205 can be fixed on the same rail 201 as the lighting fittings 200. The additional lighting unit 205 is provided with bracket 270 for this purpose. It will be clear to the person skilled in the art that the lighting unit can also be fixed in ways other than with a bracket 270.

In the example of FIG. 4 the additional lighting units 205 are provided with their own connection 275 to the power supply.

FIG. 5 shows a part of a third embodiment of a plant illumination device according to the invention. In this embodiment again, assimilation lamps are used in known lighting fittings in combination with additional lighting units 5.

This embodiment comprises an additional lighting unit 5 with two separate housings 30, each of which comprises at least one additional light source. In the example the housings are substantially cylindrical in shape. An end plate 31 is fitted on each of the ends of the housings 30. The housings 30 are fixed in pairs on one or more mountings 32. In the example of FIG. 5 two mountings are preferably used, each in the vicinity of one end of the housings 30. Since just an additional light source is present in the housings 30, the first light sources are used separately, i.e. in their own lighting fitting.

In the example of FIG. 5 the housing comprises a closed part 60 and a transparent cover 61. A reflector can be accommodated in or on the closed part.

A hanging means for fixing the plant illumination device in the greenhouse is provided in each of the mountings 32. The crop lighting devices according to the invention are preferably hung from the roof structure of the greenhouse. In the example of FIG. 5 the hanging means is in the form of an eye 33.

In the example of FIG. 5 the mountings 32 are each provided with two adjusting slots 34. A fixing bracket 35 is fitted on each of the housings 30 in the vicinity of the ends. Each fixing bracket has an opening for receiving an adjusting element. In this example the adjusting element is a bolt 36 with a nut.

The mounting 32 in this example is arranged against the fixing brackets 35 of two housings 30. The mounting 32 is positioned in such a way relative to the fixing brackets 35 that an adjusting element such as bolt 36 can be pushed through the opening in a fixing bracket and one of the adjusting slots 34. By fitting a nut on each of the bolts 26, the fixing brackets are each connected to an appropriate mounting 32.

The adjusting slots 34 ensure that the position of the housings 30 relative to the mounting 32 can be varied.

As an alternative, it is also possible for the fixing brackets 35 to be equipped with an adjusting slot and for the mounting to be equipped with an opening for the adjusting element, or for both to have an adjusting slot.

It is also possible for only a single housing to be fixed on the mounting 32. The mounting need then only have a single adjusting slot 34 or opening for receiving an adjusting element. In such a case the eye 33 will preferably be situated substantially directly above the central axis of the single housing to be supported.

FIGS. 6A-C show three possible positions of the embodiment of the additional lighting unit 5 according to FIG. 5, in this case the end plate 31 being omitted in order to show more detail. For the desired sealing of the housing it is, however, advantageous if the end plates 31 are present during use. The housing as a whole in the use situation preferably has sealing of at least IP67.

FIGS. 6A-C again show the mounting 32 with hanging eye 33 and adjusting slots 34. The housings 30 are connected to fixing brackets 35, which in turn are connected by bolt 36 to the mounting 32.

In this example the mounting is provided near the adjusting slots 34 with a scale division 38, which makes it easier to position and/or to orient the housing 30 relative to the mounting 32 and relative to the other housing 30 connected to the same mounting.

FIG. 6 shows the housing 30 and what is inside it in greater detail than FIG. 5.

At least one LED holder 41 is present in the housing 30. Said LED holder 41 is intended for accommodating an additional light source 44. This additional light source 44 is preferably a set of a number of light-emitting diodes (LEDs). The use of a single LED as the additional light source 44 is theoretically possible, but in practice it is found that a number of LEDs complement the spectrum of the first light source in a more effective way because of the greater light output.

It is also possible for a number of LED holders 41 to be present in the housing. Furthermore, it is possible for all LEDs in the set of LEDs to have substantially the same spectrum, or for LEDs with different spectra to be combined in a single set.

In the example of FIG. 6 a lens 42 is fitted on, the housing at the position of the additional light source. This lens directs the light from the additional light source 44 above it in the desired direction towards the plants. The lens 42 can be fitted only at the position of one or more additional light sources 44, or it can also extend along the full length of the housing 30. As an alternative, a transparent cover 61 without lens can also be used.

In the example of FIG. 6 a lens 42 is used, which lens extends along the full length of the housing 30. The housing 30 furthermore comprises upper part 47. Upper part 47 is provided with an edge 45 into which the lens 42 can be slided. The upper part 47, the lens 42 and the end plates 31, and the means by which they are fixed to each other, in this example together form the housing 30. These three parts are preferably arranged in such a way that together they achieve sealing in class IP67. In order to enable them to achieve this, additional components such as seals can be used.

In an advantageous embodiment the upper part 47 comprises cooling fins 43 for removal of the heat produced in the housing 30. This gives upper part 47 a complex shape, which is, however, easy to obtain by means of extrusion. Upper part 47 is therefore preferably an extruded profile.

FIG. 7 shows an alternative embodiment of an additional lighting unit 5. In this variant a single housing 30 of the type described above is used. Here again, cooling fins 43 are present in the upper part 60, just as in FIG. 4. The housing comprises a transparent cover 61, which in this example is not provided with one or more lenses. As an alternative, one or more lenses can in fact be present.

The additional lighting units 5 of FIG. 7 comprise one or more additional light sources.

The additional lighting units 5 of FIG. 7 and those according to the other illustrated embodiments, and additional lighting units according to the invention in general, can be hung from the roof structure of a greenhouse, but they can also be fixed to the trusses of a greenhouse. They can be arranged either horizontally or vertically. They can also be fitted on supports or mountings made specially for the units. The additional lighting units can also be placed in between or beside the plants in the greenhouse.

FIG. 8 relates to the method for designing assimilation lighting according to the invention.

FIG. 8A shows a desired spectrum Lw. The desired spectrum Lw is the optimum spectrum for a particular plant in certain circumstances, for example the optimum spectrum for promoting fruit set in cucumbers. In the graphs of FIG. 8 the wavelength λ is plotted on the horizontal axis and the intensity I is plotted on the vertical axis.

Three spectra are shown in FIG. 8B. L1 indicates the spectrum of a conventional assimilation lamp, for example a gas discharge lamp. Such assimilation lamps for use in greenhouses have a power of at least 250 W (usually even 400 W or more). The gas discharge lamp with the spectrum L1 will be used as a first light source in a plant illumination device according to the invention.

It can be seen from FIG. 8B that spectrum L1 of the first light source has a dip at and around λ1. In the desired spectrum Lw there is no dip at this point; it runs on more or less at the same level.

An LED A has spectrum L2. This spectrum has quite a narrow peak, which is characteristic of a LED. LED A with the spectrum L2 has its peak at or in the region of λ1. The spectrum L2 differs significantly from the spectrum L1; L2 has a peak and/or a dip at totally different wavelengths from those of the spectrum L1. In this example the shape and the location of the spectrum are also different.

L3 indicates the line the combination of the spectra L1 and L2. L3 is in fact the sum of L1 and L2 produces. L3 does not have any undesired low level at and around A1. In this way spectrum L2 complements spectrum L1.

L3 approaches the desired spectrum considerably better than L1 or L2. LEDs of type A which have the spectrum L2 are therefore suitable for use in an additional light source which is used together with the assimilation lamp with the spectrum L1 in a plant illumination device according to the invention. The assimilation lamp with the spectrum L1 and the additional light source with a set of LEDs with the spectrum L2 together produce a spectrum which is close to Lw and is therefore suitable for promoting fruit set in cucumbers.

1. Plant illumination device for exposing to light plants that are to be grown in a greenhouse, which plant illumination device comprises:
at least one lighting fitting with a first light source, wherein the first light source is an assimilation lamp the first light source having a first spectrum, and said first light source having a power of at least 250 W;
at least one additional lighting unit with an additional light source, wherein that at least one additional light source has an additional spectrum which differs significantly from the first spectrum, and wherein the additional spectrum complements the first spectrum in at least a wavelength range which plays a role in a biological process in the plants to be exposed to light.

2. Plant illumination device according to claim 1, wherein the at least one additional lighting unit is connected to the lighting fitting.

3. Plant illumination device according to claim 2, wherein the at least one additional lighting unit is integral with the lighting fitting.

4. Plant illumination device according to claim 1, wherein the at least one additional light source is a set of light emitting diodes (LEDs).

5. Plant illumination device according to claim 1, wherein the at least one additional spectrum complements the first spectrum with blue light.

6. Plant illumination device according to claim 1, wherein the at least one additional spectrum complements the first spectrum with red or far-red light.

7. Plant illumination device according to claim 1, wherein the combination of the first spectrum and the at least one additional spectrum produces a combined spectrum which substantially corresponds to the spectrum of natural morning light.

8. Plant illumination device according to claim 1, wherein the combination of the first spectrum and the at least one additional spectrum produces a combined spectrum which substantially corresponds to the spectrum of natural light of a specific season.

9. Plant illumination device according to claim 1, wherein the at least one additional lighting unit is suitable for accommodating a number of additional light sources.

10. Plant illumination device according to claim 9, wherein the additional light sources can each be switched on and off separately.

11. Plant illumination device according to claim 9 wherein the additional light sources have different additional wavelength spectra from each other.

12. Plant illumination device according to claim 1, wherein the plant illumination device comprises a number of additional lighting units.

13. Greenhouse lighting system comprising:
a plurality of lighting fittings, each provided with a first light source, wherein the first light source is an assimilation lamp, the first light source having a first spectrum, wherein the first light source has a power of at least 250 W;
a plurality of additional lighting units, each of which is provided with an additional light source, wherein the additional light source has an additional spectrum which differs significantly from the first spectrum;
and wherein the additional spectrum complements the first spectrum in at least a wavelength range which plays a role in a biological process in the plants to be exposed to light.

14. Greenhouse provided with a greenhouse lighting system according to claim 13.

15. Method for designing assimilation lighting, comprising:
determining the spectrum of a first light source, wherein the first light source is an assimilation lamp with a power of at least 250 W;
comparing the spectrum of the first light source with a spectrum desired for supporting a biological process in a crop to be exposed to light;
determining in what wavelength range sufficient intensity is lacking in the spectrum of the first light source compared with the desired spectrum; and
selecting one or more additional light sources which have a spectrum with sufficient intensity in the wavelength range in which insufficient intensity is present in the spectrum of the first light source.

16. Plant illumination device according to claim 1, wherein the assimilation lamp is in the form of an incandescent lamp.

17. Plant illumination device according to claim 1, wherein the assimilation lamp is in the form of a gas discharge lamp.

18. Plant illumination device according to claim 5, wherein the blue light has a spectrum with peak in the wavelength range 350-500 nm.

19. Plant illumination device according to claim 6, wherein the red and/or far-red light has a spectrum with peak in the wavelength range 600-800 nm.

20. Plant illumination device according to claim 7, wherein the combination of the first spectrum and the additional spectrum produces a combined spectrum which substantially corresponds to the spectrum of natural evening light.

21. Plant illumination device according to claim 8, wherein the combination of the first spectrum and the additional spectrum produces a combined spectrum which substantially corresponds to the spectrum of natural light of a specific region on earth.
